(19) United States
(12) Patent Application Publication
(10) Pub. No.: US 2008/0131593 A1
(43) Pub. Date: Jun. 5, 2008

(54) Contact lens mold printing systems and processes

(76) Inventors: P. Mark Powell, Jacksonville, FL (US); Michael Francis Widman, Jacksonville, FL (US); Michael J. Strong, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/767,293

(22) Filed: Jan. 29, 2004

(51) Int. Cl. B05D 5/04; B05C 11/00

(52) U.S. Cl. 427/133; 118/264

(57) ABSTRACT

The present invention provides systems and methods of printing contact lens molds in an inert atmosphere for use in manufacturing tinted contact lenses. Disclosed herein are inert atmosphere chambers and isolation shutters that are capable of quickly opening and closing to permit printing of contact lens molds in such a fashion that prevents migration and entrainment of air into the inert atmosphere chamber. Contact lens mold printing systems are also disclosed that are useful for printing contact lens molds in an inert atmosphere.

### FIELD OF THE INVENTION

The invention relates to methods useful in the production of tinted contact lenses. In particular, the invention provides methods in which contact lens molds are printed for producing tinted contact lenses.

### BACKGROUND OF THE INVENTION

The use of tinted contact lenses to alter the natural color of the iris is well known. Many colorants that are used to produce tinted lenses generally are composed of a binding polymer and pigments. In one method of manufacturing tinted contact lenses as described and claimed in U.S. application Ser. No. 10/027,579, incorporated in its entirety herein by reference, the colorant is applied to uncured lens material by transfer of the colorant from a mold surface to the lens material, and the lens material is subsequently cured. As disclosed in U.S. application Ser. No. 10/027,579, colorant transfer can be carried out using a printing pad containing a colorant composition that is pressed against a molding surface of an optical mold. The colorant composition, which typically includes a solvent component, is allowed to dry to provide tinted lens molds. The tinted lens molds are typically stored in an atmospheric environment until ready for use to prepare the tinted lenses. Because lens molds can adsorb oxygen that inhibit curing of the lens material, the lens molds are typically vacuum degassed to remove excess oxygen prior to formation of the lens. After extensive degassing, often requiring up to 8 hours or more, the lens molds are filled with a polymerizable lens material that is subsequently cured.

Because oxygen tends to inhibit the curing of certain types of lens material, there remains the need to minimize exposure of the lens molds to atmospheric conditions during tinted contact lens preparation. Many contact lens tinting methods also involve “off-line” pad printing wherein the lens molds are printed and filled with lens material in two separate operations. Because transport of the printed lens molds through the atmosphere between these operations often contaminates the lens mold surfaces with oxygen, there also remains a need to conduct “in-line” pad printing and lens material filling that minimizes lens mold exposure to oxygen. Thus, the present invention addresses these problems, as well as other problems, encountered in preparing tinted contact lenses.

### SUMMARY OF THE INVENTION

The present invention provides, inter alia, a tinted contact lens manufacturing process that includes conveying a contact lens mold in an inert atmosphere chamber, opening the chamber, printing the contact lens mold, and closing the chamber. Accordingly, in one aspect of the present invention, there is provided a method of applying a colorant to a contact lens mold, including: conveying a contact lens mold through an inert atmosphere chamber, the inert atmosphere chamber comprising an isolation shutter being capable of opening and closing; maintaining an overpressure of inert gas in the inert atmosphere chamber; opening the isolation shutter; bringing a printing device from a position external to the inert atmosphere chamber to a position internal to the inert atmosphere, the printing device comprising a colorant; applying the colorant to the contact lens mold; bringing a printing device from a position internal to the inert atmosphere chamber to a position external to the inert atmosphere; and closing the isolation shutter. The overpressure of inert gas in the inert atmosphere chamber typically provides that the atmospheric oxygen around the lens mold is sufficiently low to cause little or no inhibition of the curing of the lens material.

In another aspect of the present invention there is provided a contact lens mold printing system including an inert atmosphere chamber being capable of conveying contact lens molds therethrough, the chamber capable of maintaining an inert atmosphere environment, the chamber having an isolation shutter being capable of opening and closing, and a printing mechanism located external to the chamber, the printing mechanism capable of applying a colorant to the contact lens mold in the chamber when the isolation shutter is opened.

In still another aspect of the present invention there is provided an isolation shutter that is used in a contact lens mold printing system. In this aspect of the invention, the isolation shutter is capable of minimizing the exposure of oxygen to contact lens molds in an inert environment and capable of drying printer pads. The isolation shutter includes a plate slidably situated adjacent to the inert environment, the plate having at least one edge and a surface. The plate edge includes at least one gas inlet port and a sealing edge. The plate surface includes at least one gas outlet port, wherein the plate comprises at least one channel in fluidic communication between the gas inlet port and the gas outlet port.

In yet another aspect of the present invention, there are provided methods for applying colorants to contact lens molds that optionally use an isolation shutter. In this aspect of the invention, there are provided methods that include maintaining an overpressure of inert gas in an inert atmosphere chamber including at least one contact lens mold; introducing a printing device having colorant into the chamber through an opening; applying the colorant to the contact lens mold; and removing the printing device from the chamber.

### BRIEF DESCRIPTION OF THE DRAWINGS

FIG. 1 is a plan view of one embodiment of a contact lens mold printing system of the present invention. The motion of back curve mold pallets and front curve mold pallets is depicted using arrows.

FIG. 2 is a plan view of a portion of the contact lens molding system of FIG. 1 residing in the dashed box region 2. The motion of an actuator arm and isolation shutters is depicted using arrows.

FIG. 3 is an elevational schematic illustration of one embodiment of a contact lens molding system. The motion of inert gas is depicted using arrows.

FIG. 4 is an elevational schematic illustration of one embodiment of a contact lens molding system. The motion of the several components is depicted using arrows.

FIG. 5 is an elevational schematic illustration of a portion of the contact lens mold printing system of FIG. 1 residing in the dashed box region labeled “2”. The motion of the pallets is depicted using horizontal arrows, and the motion of pad printer heads is shown using vertical arrows.

FIG. 6 is an elevational view of an isolation shutter, which corresponds to the view along the 6-6 direction of the isolation shutter section in FIG. 8.

FIG. 7 is a sectional view of an isolation shutter, which corresponds to the sectional view along the 7-7 direction of the isolation shutter in FIG. 9.

FIG. 8 is a sectional view of the isolation shutter of FIG. 6, the section taken along line 8-8.

FIG. 9 is a plan view of an isolation shutter.

### DETAILED DESCRIPTION OF ILLUSTRATIVE EMBODIMENTS

Methods of manufacturing tinted contact lenses are described and claimed in U.S. application Ser. No. 10/027,579 (“the '579 application”) which is incorporated in its entirety herein by reference. As disclosed in the '579 application, colorant is applied to a lens mold, which is subsequently filed with a polymerizable lens-forming material, and the colorant is transferred from the mold surface to the lens material. The '579 application also discloses that colorant transfer can be carried out using a printing pad containing a colorant composition that is pressed against a molding surface of a contact lens mold. The colorant composition, which typically includes a solvent component, is allowed to dry to provide tinted lens molds.

The tinted contact lens mold manufacturing processes of the present invention generally include the steps of conveying a contact lens mold in an inert atmosphere chamber, opening the chamber, printing the contact lens mold, optionally applying air to print pads, and closing the chamber. Materials of construction of the inert atmosphere chamber typically include metals such as aluminum or steel, and plastics such as transparent acrylics and the like. The contact lens molds are desirably transported in an inert atmosphere environment to minimize the exposure of the molds to oxygen. In this regard, the methods of the present invention typically include the steps of conveying a contact lens mold through an inert atmosphere chamber, such that the molds are transported in an inert environment between a source of molds, such as an injection molding machine, and the mold printer. For the purpose of minimizing the volume of the inert atmospheric chamber, the mold printer is desirably located external and adjacent to the inert atmospheric chamber. Maintaining a low concentration of oxygen in the inert atmosphere chamber is typically achieved by infusing inert gas at various locations along the chamber. Oxygen migration into the inert atmosphere chamber is typically minimized during printing by fitting the inert atmosphere chamber with an isolation shutter that is capable of opening to permit the mold printer to print the contact lens molds contained within and then closing the isolation shutter to seal the chamber. For the purposes of minimizing the exposure of the contact lens molds to oxygen, in a preferred embodiment the lens mold remains in the inert atmosphere chamber while the isolation shutter is opened and the printing mechanism reaches into the inert environment to apply colorant to the molds. Alternatively, the contact lens molds can be lifted out of the inert atmosphere chamber for printing, however this embodiment typically exposes the contact lens mold to a greater amount of oxygen than desired.

A low concentration of oxygen is typically maintained by applying an overpressure of inert gas in the inert atmosphere chamber. Any type of inert gas can be used, for example, argon, helium, nitrogen, and any combination thereof. Nitrogen gas is preferably used. Suitable commercial sources of inert gas typically provide inert gas purity of about 99%, although commercial sources of higher and lower purity grades can also be used. For example, 97% nitrogen is typical for keeping the oxygen content in the inert atmosphere at a concentration of no more than about 3%; 98% nitrogen is more typically used to keep the oxygen concentration below about 2%; 99% nitrogen is even more typically used to keep the oxygen concentration below about 1%; 99.5% nitrogen is further typically used to keep the oxygen concentration below about 0.5%; and 99.9% or purer nitrogen is even more typically used to keep the oxygen concentration below about 0.1%. As used herein, “%” refers to “weight percent” unless otherwise indicated.

The time during which the isolation shutter is open is typically kept short to minimize diffusion of oxygen into the atmospheric chamber. In achieving this, the following steps are typically achieved in quick succession: opening the isolation shutter; bringing a printing device from a position external to the inert atmosphere chamber to a position internal to the inert atmosphere; applying the colorant to the contact lens mold; bringing the printing device from a position internal to the inert atmosphere chamber to a position external to the inert atmosphere; and closing the isolation shutter. In certain embodiments of the present invention, the inert atmosphere will typically vary in oxygen content as the shutter is opened and closed. Although it is desirable to minimize the oxygen content, it should be recognized that absolute inert atmosphere purity is not required. Accordingly, it should be realized that some oxygen can diffuse into the inert atmosphere chamber while the isolation shutter is opened. In this regard, a backfill of inert gas into the atmosphere chamber is preferably used to provide that the inert atmosphere chamber is composed of less than about 3 weight percent oxygen while the isolation shutter is opened. Likewise, it is desirable to minimize the amount of the time that the isolation shutter is open. In this regard, the isolation shutter remains open for typically less than about 2 seconds, more typically less than about 1.5 seconds, and even more typically less than about 1 second.

In embodiments in which the lens molds are manufactured and conveyed into the inert atmosphere chamber, it is desirable that the contact lens molds are exposed to air for no more than about 60 seconds, and preferably to less than about 15 seconds between their manufacture (e.g. injection molding) and entry into the inert atmosphere chamber. The total air exposure time prior to entry into the inert atmosphere chamber typically depends somewhat additional oxygen exposures that occur during subsequent lens fabrication processes, such as the assembling of the back and front curve lens molds. Total air exposure times of the lens molds prior to entry into the inert atmosphere chamber and subsequent fabrication processes is typically less than about 120 seconds. Reducing oxygen exposure of contact lens molds in tinted contact lens manufacturing processes is further described in U.S. Pat. Nos. 6,241,918 and 6,610,220, which are incorporated by reference herein in their entirety.

In certain embodiments, the methods of the present invention are conducted so that the atmosphere within the inert atmosphere chamber is composed of less than about 0.5 weight percent oxygen prior to opening said isolation shutter. Typically, in embodiments in which the atmosphere in the inert atmosphere chamber is composed of less than about 0.5 weight percent oxygen, the oxygen concentration is monitored continuously and recorded at about two seconds after closing the isolation shutter. The motion of the isolation shutter also can affect the amount of oxygen content in the inert atmosphere chamber. Although it is possible that any type of mechanism can be used for opening and closing the isolation shutter, for example by use of a hinged joint for angularly opening and closing the isolation shutter, it is preferred that the isolation shutter slidably opens and closes to minimize the entrainment of atmospheric oxygen into the inert atmosphere chamber. Preferably, the isolation shutter is opened quickly, for example in about 0.1 seconds, and in such a fashion that minimizes the formation of gas currents (i.e. air entrainment) during opening and closing of the isolation shutter.

While not being bound by any theory of operation of the invention, it is believed that the overpressure of inert gas in the inert atmosphere chamber typically maintains a concentration of oxygen around the lens mold that is sufficiently low that there is little or no inhibition of the curing of the lens material in a subsequent cure process. When the isolation shutter is opened, a “puff” of inert gas arising from the inert gas overpressure is typically released. In certain preferred embodiments, the inert gas is fed into the inert atmosphere chamber to provide a flux of inert gas exiting the inert atmosphere chamber at the opened isolation shutter. This inert gas flux helps to reduce the backflow of air, i.e., oxygen, into the inert atmosphere chamber. Suitable overpressures of inert gas typically give rise to an inert gas velocity of at least about 0.5 meters per second. Such gas velocities can be measured in a variety of ways, for example, by using an anemometer positioned adjacent to an opening in the inert atmosphere chamber. Preferably, the opening in the inert atmosphere chamber is provided by maintaining the isolation shutter in the opened position.

The present invention also provides contact lens mold printing systems. A number of suitable methods can be used applying the colorant to the contact lens mold, including spray coating, ink jet printing, screen printing, and preferably pad stamping. The contact lens mold printing systems of the present invention are typically used for carrying out the methods described in preparing tinted contact lens molds as described herein. The contact lens mold printing systems typically include an inert atmosphere chamber being capable of conveying contact lens molds therethrough. Preferred inert atmosphere chambers typically include an isolation shutter that is capable of opening and closing, which allows a printing mechanism to be located external to the chamber. Locating the printing mechanism external to the chamber helps to minimize the total volume required for the inert atmosphere chamber. Accordingly, when the isolation shutter is opened, the printing mechanism is capable of applying a colorant to the contact lens mold in the chamber.

The contact lens mold printing systems of the present invention typically include inert atmosphere environments that have less than about 0.5 weight percent oxygen. In providing such inert atmosphere environments, the systems typically include a chamber that has at least one inert gas inlet to provide an over pressure of inert gas. In certain preferred embodiments, the inert atmosphere chamber further includes at least one inert gas outlet. The inert gas outlets and inlets have a variety of uses and can further be connected to one or more vacuum sources. One use involves flushing the inert atmosphere chamber with inert gas. Another use of the inert gas outlets and inlets involves providing a source of inert gas for flowing inert gas out of the opened isolation shutter, which in certain embodiments helps to reduce oxygen backflow into the contact lens mold printing systems.

The contact lens mold printing systems include an inert atmosphere chamber that typically includes at least one isolation shutter, more typically at least two, even more typically at least three, and even further typically at least four such shutters. In certain embodiments it is desirable that two or more of the isolation shutters are connected, such as by way of a manifold or suitable connector, for connecting to a suitable actuator that opens and closes them together. The isolation shutters are opened and closed to enable the printing mechanism to print the contact lens molds that are contained within the inert atmosphere chamber. Although it is preferred to have the printing mechanism enter the inert atmosphere chamber to print the contact lens molds contained therein, it is also envisioned that the contact lens molds can be lifted out of the inert atmosphere chamber and subsequently or simultaneously printed. Combinations of these motions are also envisioned. There are a number of ways in which the isolation shutter can be opened and closed, such as by the use of hinges and actuators. In preferred embodiments, the isolation shutters are capable of slidably opening and closing. Suitable isolation shutters that are capable of slidably opening and closing typically include a gasket capable of being in sealable contact with the inert atmosphere chamber and the isolation shutter. Suitable gaskets are typically made out of a compliant material, such as a polymeric material, such as a rubber. Preferably, the gasket is made of silicone. The gaskets are suitably affixed around the edge of the isolation shutter using any of variety of methods, such as by way of, for example, a compression fit or adhesive.

In the contact lens mold printing systems of the present invention, any one of a variety of printing mechanisms can be used as described herein; typically two or more printing mechanisms are included. Two or more printing mechanisms can further be “ganged” together to simultaneously open and close by way of a suitable mechanical manifold. Alternatively, the isolation shutters can be independently opened and closed. The printing mechanism can be suitably located external to the inert atmosphere chamber, such as in air. Typically, the printing mechanism is located in air in vicinity to at least one isolation shutter. In embodiments containing two or more printing mechanisms, each printing mechanism is typically located close enough to an isolation shutter that the printing mechanism can print one or more lens molds revealed when the shutter opens. Preferred printing mechanisms typically include pad printers having at least one stamping pad, in which ink is transferred from an ink cup to a cliché etching and then to a contact lens mold by way of a stamping pad. Several sets of printing plates and isolation shutter combinations can be used for providing different colorants, tints, and tint designs. Further details of suitable printing processes for contact lens molds can also be found in, for example, U.S. Pat. No. 6,276,266, issued on Aug. 21, 2001 to Dietz. et al., which is incorporated by reference herein.

In certain preferred embodiments of the present invention, the printer pads of a suitable pad printer are at least partially dried by application of a suitable drying gas over the surface of an inked pad prior to print stamping of the lens molds. A variety of ways to blow a drying gas, such as air, over inked pads are envisioned, such as by way of fans and pressurized conduits. In certain preferred embodiments the pads are dried by way of drying gas outlet ports fashioned as part of the isolation shutter. In these embodiments, there are provided isolation shutters that are capable of minimizing the exposure of oxygen to contact lens molds in an inert environment and capable of drying printer pads. These isolation shutters typically include a plate that is situated adjacent to the inert environment for opening and closing in a sliding fashion. The plate typically includes at least one edge and a surface, the at least one edge having at least one gas inlet port, and the surface having at least one gas outlet port. The plate typically includes at least one channel in fluidic communication between the gas inlet port and the gas outlet port. Thus, a drying gas source applied to the gas inlet port is capable of being transported through the plate and out the gas outlet port in the direction of the inked stamping pads of a suitable pad printer.

In other embodiments of the present invention there are provided methods for applying colorant to contact lens molds that may, but do not require, the use of one or more isolation shutters. In this aspect of the invention, there are provided methods that include maintaining an overpressure of inert gas in an inert atmosphere chamber including at least one contact lens mold; introducing a printing device having colorant into the chamber through an opening in the chamber; applying the colorant to the contact lens mold; and removing the printing device from the chamber. In embodiments that do not require the opening and closing of a shutter, a positive pressure of inert gas is maintained within the inert atmosphere chamber to maintain the desired low concentration of oxygen in the chamber. In this embodiment, positive pressure of inert gas is provided to the chamber to prevent the inflow of ambient oxygen. One or more exhaust vents are typically placed around the openings of the escaping inert gas to transport the inert gas away from the system and prevent the migration of oxygen into the inert atmosphere chamber. Exhaust vents also provide for the safety of workers. In these embodiments, the inert gas flow rates are selected to maintain a gas velocity of about 100 feet per minute escaping from the opening in the inert atmosphere chamber where the printing device enters the chamber. In embodiments having continually opened shutters, or openings with no shutters, the inert gas typically enters the chamber at a higher volumetric flow rate compared to the open-closed shutter embodiments described hereinabove. The colorants can be applied to the lens molds in these embodiments by following the general procedures as described hereinabove.

These and other embodiments and equivalents of the present invention are further illustrated by reference to the following drawings.

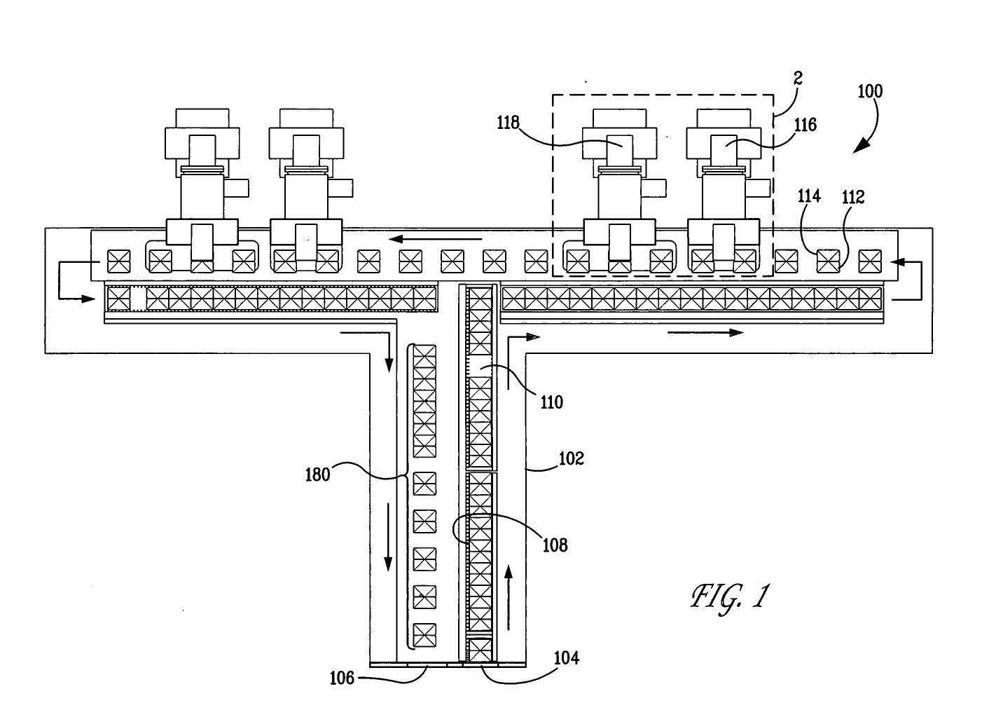

Referring to FIG. 1, there is provided a contact lens mold printing system 100 including an inert atmosphere chamber 102 that envelopes a pallet feed conveyor 110 having conveyor rollers 108 upon which back curve mold pallets 112 and front curve mold pallets 114 are transported. As shown by the directional arrows, the pallets enter the inert atmosphere chamber through a pallet input port 104 and are conveyed through the inert atmosphere chamber to a first printer bank 2, past a second printer block (not labeled), through an area for post printing processing stages 180, and then through the pallet exit port 106. The back curve pallets and front curve pallets (“pallets”) each include at least one back curve contact lens mold and at least one front curve contact lens mold, respectively, for use in preparing a tinted contact lens. The pallets typically enter the pallet inlet port 104 containing the contact lens molds (not shown) directly from an injection molding station (not shown) that is used to freshly prepare the contact lens molds. Inert gas is typically supplied to the inert atmosphere chamber to provide a positive pressure of inert gas escaping from the pallet inlet and exit ports. This positive pressure typically helps to maintain the required low concentration of oxygen in the inert gas chamber, as described herein. An exhaust vent (not shown) is typically placed above the inlet and exit ports to transport away the escaping gas. Typically, contact lens molds are transported from an injection molding step into the lens mold printing system through atmospheric air, although in certain other embodiments the injection molding and printing systems can be integrated within an inert atmosphere environment. In embodiments in which the molds are transported through air, it is desirable to minimize the exposure of the contact lens molds to atmospheric oxygen. Typically, the time between injection molding of the lens molds and entering into the system is on the order of less than about 10 minutes, more typically less than about five minutes, even more typically less than about two minutes, and most typically less than about a minute. As shown in FIG. 1, the printing bank 2 contains a two-ganged printer 116 and a three-ganged printer 118, for printing the front curve molds located on two and three front curve pallets, respectively.

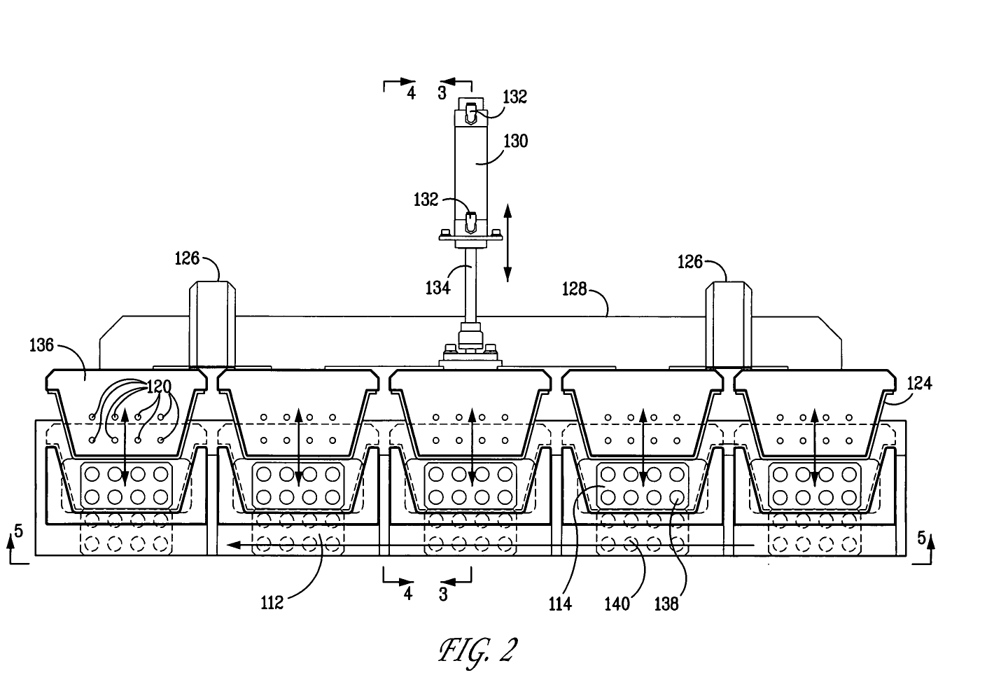

Referring to FIG. 2, there is provided a top-down schematic illustration of a portion of the contact lens molding system of FIG. 1 residing in the dashed box region 2. The motion of an actuator arm 134 and isolation shutters 136 is depicted using arrows. Each of the back curve pallets 112 is depicted as having eight back curve pallet mold wells 140, and each front curve pallet 114 is depicted as having eight front curve pallet mold wells 138. A higher or lower number of mold wells is envisioned for each of the pallets. Typically the number of mold wells for a the back curve molds and the front curve molds (not shown) will be the same to form a matched set for use in preparing contact lenses. In this top-down schematic, five isolation shutters 136 are depicted in the opened position, revealing the front curve pallets 114. The back curve pallets 112 and back curve mold wells 140 are depicted with dashed lines to indicate their being beneath the top portion of the inert atmosphere chamber 102, and not accessible by a suitable printer (not shown) when the isolation shutters are in the opened position. Dashed lines are also shown outlining each of the isolation shutters 136 in the closed position. Each of the five isolation shutters 136 has a gasket 124 that forms a seal with the inert atmosphere chamber 102. In this embodiment, each of the isolation shutters is connected to a shutter manifold 128 for simultaneously opening and closing the isolation shutters by way of an actuator arm 134 connected to a shutter actuator 130. The shutter actuator 130 operates by way of shutter actuator gas ports 132, which are connected to a pneumatic gas supply for moving the actuator arm 134. Opening and closing of the isolation shutters connected to the shutter manifold is by way of shutter guide rails 126. Front curve molds (not shown) residing in each of the front curve mold wells 138 are typically transported from an earlier section of the pallet feed conveyor 110, as shown in FIG. 1, to a position for printing beneath one of the isolation shutters 136. Typically, the isolation shutters are closed prior to the unprinted front curve molds being moved into position beneath the isolation shutter. A controller (not shown) monitors the position and controls the movement of each of the pallets, thereby monitoring the position of each of the molds. When an unprinted front curve mold is in position beneath an isolation shutter, the isolation shutter quickly opens as described elsewhere herein, and a set of print pads situated above the front curve molds and external to the inert atmosphere chamber are actuated to print the front curve molds. Each of the isolations shutters 136 is depicted as having a set of eight pad blow outlet ports 120, which are in fluidic communication with a drying gas supply (not shown). Prior to printing the front curve molds (and while the isolation shutters 136 are still closed), the pad blow outlet ports 120 direct a drying gas towards each of the inked pads for partially drying the ink on the print pads prior to the printing step. The printing step also occurs quickly and the isolation shutter is quickly closed, typically all within a second, to minimize the amount of air entering the inert atmosphere chamber. The five isolation shutters, as depicted in this figure, are typically simultaneously printed by five sets of eight print pads (not shown). Each set of print pads may contain the same or different ink color. Typically, each of the print pads on a particular set will be inked with the same colored ink, so as to provide a color-matched set of contact lens molds for each set of pallets.

FIG. 3 provides an elevational schematic illustration of a portion of one embodiment of a contact lens molding system. The orientation of the view of FIG. 3 is comparable to viewing the embodiment depicted in FIG. 2 along the 3-3 direction. FIG. 3 depicts a shutter actuator 130 and a actuator arm 134 connected to one of the isolation shutters 136, which is illustrated being in the closed position. Beneath the isolation shutter is the front curve pallet, and beneath the front curve pallet is a walking beam 148, which helps to position and align the front curve pallet with the printer pads (not shown). Typical walking beams include fingers that come up and slide the pallets along the beam to precisely position the pallets holding the molds along the rails under the print pads (not shown). Tolerances of the rails are typically less than about 1 mm, and tolerances of the walking beam are typically less than about 0.5 mm. The back curve pallets 112 reside adjacent to the front curve pallets 114. When the shutter actuator is activated, the actuator arm 134 slides the isolation shutter to the left, as depicted by the arrow, which provides access of the printer pads (not shown) to the front curve molds (not shown) residing on the front curve pallets. A second set of pallets (not labeled) is shown residing on the pallet feed conveyor 110, which is depicted in FIG. 1 as moving in direction opposite to the set of pallets below the isolation shutter.

The illustration in FIG. 3 also provides further details pertaining to the supply of inert gas into a portion of the inert atmosphere chamber. The motion of inert gas is depicted using arrows, which is shown entering the inert gas chamber by way of a combination of a fast inert gas feed port 142 and a slow inert gas feed port 144. The slow inert gas feed port provides overall inert gas feed during operation and transport while the isolation shutters are closed. The fast inert gas feed port is typically actuated during initial preparation of the inert atmosphere chamber and during times when the isolation shutters are in the opened position. For the purposes of flushing air, oxygen, or both out of the system, there is also provide an inert atmosphere exhaust port 150 for removing gas from the inert atmosphere chamber. The inert atmosphere exhaust port 150 is typically in fluidic communication with a vacuum source (not shown), and is especially used during times of initially preparing the inert atmosphere chamber, such as by blow down and flushing with inert gas. The inert gas velocity is typically controlled so as to avoid turbulence at high inert gas flow rates and oxygen concentration remains at a sufficient concentration, as indicated elsewhere herein, at low inert gas flow rates. During steady state conditions under normal operating conditions, overall inert gas volumetric flow rates for a commercial-scale contact lens mold printing system is between about 1000 and 2000 standard cubic feet per hour. When the isolation shutters are opened, inert gas flow rates are typically increased, for example to provide a inert gas velocity of about 100 feet per minute.

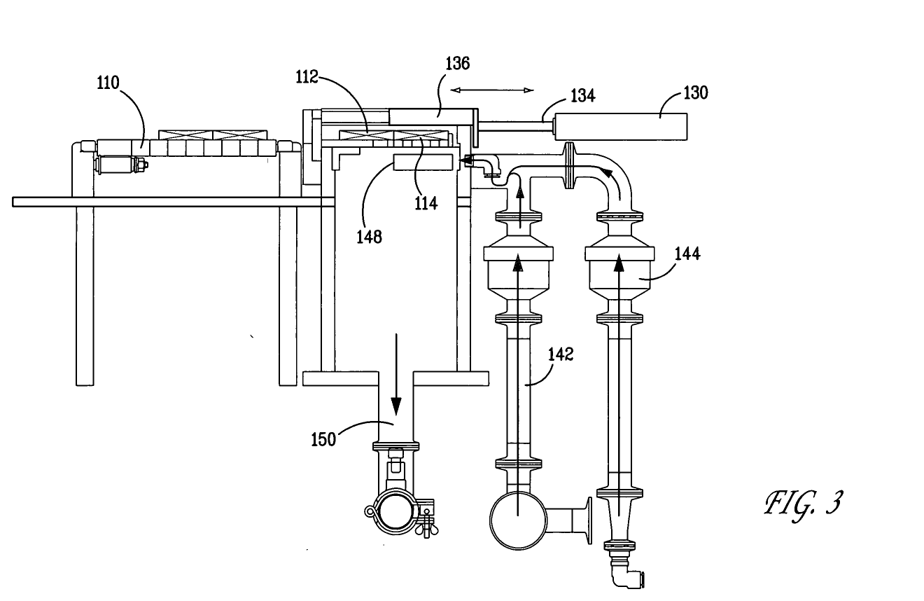

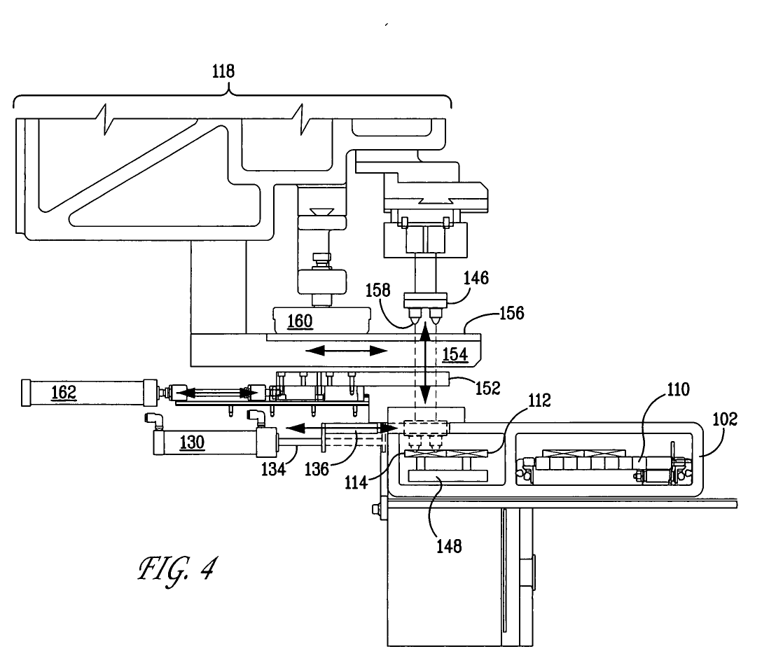

FIG. 4 provides an elevational schematic illustration of a portion of an embodiment of the contact lens molding system. The orientation of the view of FIG. 4 is comparable to viewing the embodiment depicted in FIG. 2 along the 4-4 direction. The motion of several components is depicted using arrows. For example, the inert atmosphere chamber 102 is illustrated as containing the pallet feed conveyor 110, as well as back curve pallets 112 and front curve pallets 114 that are positioned using a walking beam 148. A servo motor (not shown) for the walking beam is typically located below the walking beam and within the inert atmosphere chamber. Also shown is an isolation shutter 136 that is slidably positioned in the opened position by way of actuator arm 134, which in turn is connected to shutter actuator 130. Dashed lines indicate the position of the isolation shutter being in the closed position. As shown, the isolation shutter is in the opened position to allow the print pad plate 146 having print pads 158 to enter the opening in the inert atmosphere chamber provided by the opened isolation shutter 136. Front curve molds (not shown) that are situated on the front curve pallet 114 are then printed. Also shown in this figure is a portion of the three-gang printer 118, which includes, inter alia, print pad plate 146, print pads 158, ink cup 160, cliché 156, and cliché holder 154.

Prior to printing the front curve molds, the print pads 158 pick up ink (not shown) that is deposited on the cliché 156 by ink cup 160. The cliché 156 typically contains etchings for providing the printed patterns to be transferred from the lens molds to the contact lens (e.g., iris patterns). The cliché is held by cliché holder 154, which is capable of being horizontally positioned to permit inking of the cliché by the ink cup, inking of the print pads on the cliché, and printing of the front curve molds by the printing pads via a pad stamping process. Typically, the ink cup contacts the cliché holder 154 to provide ink on the cliché for the print pads 158. Also shown is tape plate 152 that is also horizontally positionable by way of tape plate actuator 162. The tape plate 152 is used as a resistance pressure backing for a tape (not shown) that is used for cleaning residual ink and debris from the print pads 158.

FIG. 5 provides an elevational schematic illustration of a portion of a contact lens mold printing system, such as the portion of FIG. 1 residing in the dashed box region 2. The motion of the pallets (not shown) through the inert atmosphere chamber 102 is depicted using horizontal arrows, and the motion of a two-gang pad printer 116 and three-gang pad printer 118 is shown using vertical arrows. This figure depicts print pad plates 146, each having a plurality of print pads 158 situated over a plurality of clichés 156 that are mounted on separate cliché holders 154 for each of the two-gang and three-gang pad printers, 116 and 118, respectively. Also shown is a tape take-up roller/actuator 164 and a tape feed roller 172 that provides fresh tape (not shown) to the tape plate 152. During operation, for example, front curve and back curve pallets are transported within inert atmosphere chamber 102 in the direction of the horizontal arrows. Alignment of the front curve molds beneath each of the print pad plates 146 is typically conducted by way of a walking beam. Five isolation shutters that are positioned on the inert atmosphere chamber 102 beneath the five print bad plates 146 are slidably opened to permit printing of the front curve molds located on each of the front curve pallets (not shown). Prior to opening of the isolation shutters, the tape feed roller 172 and tape take-up roller/actuator 164 advances the tape, the print pads 158 are cleaned by contacting the tape, and the print pads pick up ink from the inked cliché. The cliché is moved to a position by way of tape plate actuator 162 to permit partial drying of the inked print pads 158 by way of a drying gas blowing through a plurality of shutter blow channels located on the top surface of the isolation shutters, as described further below. Preferably, the drying gas through the pad blow outlet ports slightly dries the ink on the print pads so that the ink becomes slightly tacky on the pad surface. This slight tackiness enables the ink to stick to the front curve mold surfaces, while providing for wet (i.e., low viscosity) ink in contact with the print pad to enable release of at least a portion of the ink from the printing pads. After partial drying of the inked printer pads, the isolation shutters are opened and the printing pads are brought internal to the inert atmosphere chamber 102 and contacted with the front curve molds positioned beneath each of the printer pads. The printer pads are removed from the front curve molds and brought external to the inert atmosphere chamber 102 at which time the isolation shutters are closed. During these operations, inert gas is provided to the inert atmosphere chamber to prevent the oxygen concentration within the inert atmosphere chamber from rising above about 3%, preferably no more than about 1%, as provided elsewhere in this specification. The pallets are advanced within the inert atmosphere chamber by way of the walking beam and pallet feed conveyor, and the process is repeated.

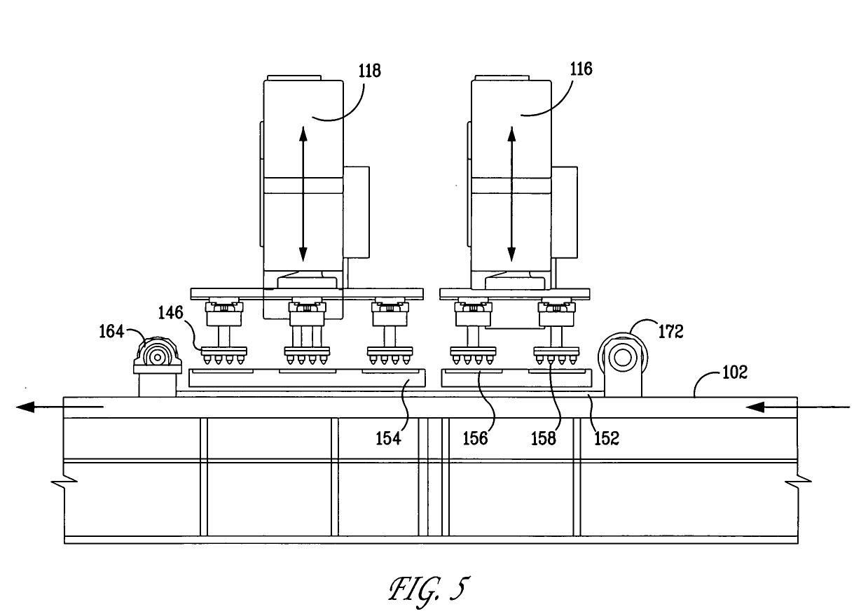

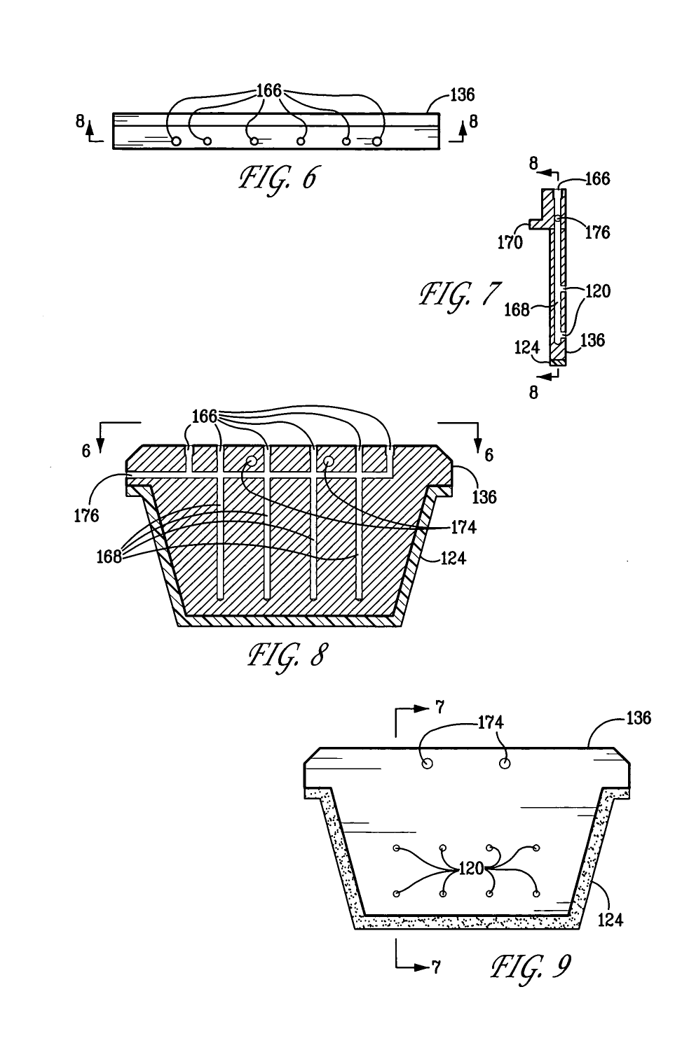

FIGS. 6-9 illustrates various views of an isolation shutter of the present invention. The isolation shutter is typically fabricated from a suitably stiff material, such as a metal or plastic. Aluminum is a suitable metal for fabricating isolation shutters. FIG. 6 provides a rear-facing elevational view of an isolation shutter 136, which corresponds to the view along the 6-6 direction of the isolation shutter illustrated in FIG. 8. In FIG. 6 there is shown a plurality of pad blow inlets 166, which are attached to a suitable drying gas source, such as air or nitrogen. FIG. 7 is a sectional view of the isolation shutter, which corresponds to the sectional view along the 7-7 direction of the isolation shutter in FIG. 9. In FIG. 7 there is illustrated a pad blow inlet port 166 that is in fluidic communication with shutter blow channel 168, which in turn is in fluidic communication with a shutter manifold channel 176 and pad blow outlet ports 120. FIG. 7 also shows location of the shutter top lip 170 and the gasket 124. FIG. 8 is a sectional view of the isolation shutter of FIG. 6, the section taken along line 8-8. In FIG. 8 there is further depicted the location of a plurality of shutter blow channels 168 that are in fluidic communication with the plurality of pad blow inlet ports 166 and shutter manifold channel 176. Shutter manifold mounting through-holes 174 are also depicted, which are used for mounting the isolation shutter 136 to the shutter manifold 128 (not shown) by way of suitable fasteners, such as bolts (not shown). Also depicted in FIG. 8 is the gasket 124 that is in contact with the edge of isolation shutter 136. FIG. 9 is a plan view of the isolation shutter 136, which further depicts shutter manifold mounting through-holes 174, pad blow outlet ports 120, and gasket 124.

### EXAMPLE

A contact lens mold printing system as described herein was used to print front curve molds for preparing tinted contact lenses. Colorant formulations (i.e., inks) contained a blue pigment suspended in a binder polymer and plasticizer. Cosmetic contact lens tint print patterns included circular and iris shaped print patterns. Front curve and back curve contact lens molds having −2.00 D and 8.3 BC were used. Nitrogen was supplied to the inert atmosphere chamber using house supply (>97% nitrogen purity) via regulators.

Results.

Oxygen Concentration: Oxygen concentration as measured at the pallet exit port varied depending on the phase of the print run cycle. Increases in oxygen concentration were most prevalent as the pallets entered the inert atmosphere chamber via the pallet inlet port, which was designed as a guillotine type door. Opening of the isolation shutters had little effect on oxygen concentration measured at the pallet exit port. Minimum and maximum levels varied somewhat depending on the nitrogen regulator pressure, as follows:

| Inlet regulator | Oxygen concentration | Oxygen concentration |
|---|---|---|
| pressure | while not printing | while printing |
| 10 psi | 0.2% | 0.5-2.5% |
| 20 psi | 0.0% | 0.3-2.0% |
| 30 psi | 0.0% | 0.2-1.6% |

Although there were regular spikes above 0.5% oxygen, levels quickly returned to 0.5% while the pallet inlet port remained closed.

Nitrogen Velocity: Nitrogen velocity was measured with an anemometer at various points around the opening of the isolation shutter. Velocities varied slightly from point to point as follows:

| | Nitrogen |
|---|---|
| Location on inert atmosphere chamber | velocity |
| Just above the open isolation shutter | 1.5 m/s |
| Inside sample ports positioned inside the inert | 1.0 m/s |
| atmosphere chamber and to the left and to the | |
| right of the isolation shutter | |
| Inside the inert atmosphere chamber on walking | 1.5 m/s |
| beam beneath open isolation shutter | |
| Inside the inert atmosphere chamber on walking | 0.5 m/s |
| beam beneath closed isolation shutter | |

Printing. Printing setup was conducted in stagnant air according to typical pad printing procedures. Print speeds and dwell times were adjusted to obtain good printed images. Nitrogen flow was then introduced into the enclosure. Due to the positive flow of nitrogen escaping from the open isolation shutter, dwell times were adjusted to zero to obtain acceptable print quality. With no dwell time, the time between prints required about six seconds. 100 pallets of eight molds each were run successfully at these conditions.

Overall results: Contact lens molds were successfully printed in an inert atmosphere (low humidity nitrogen) environment. The reduction in printer dwell time is a result of the positive flow of nitrogen blowing across the printer pads when the isolation shutter door was opened prior to the printing of the lens mold images. Without being held to a particular theory of operation, it appears that while elimination of dwell time was typically good for cycle time reduction, some dwell time appears to be desirable for the purposes of controlling print quality during the course of a long run as flash solvent levels change in the colorant composition. Flexibility in dwell times can be achieved using a number of methods, including, for example, use of a slower evaporating flash solvent, increasing the flash solvent amount, and minimizing the nitrogen velocity through the opened isolation shutter.

What is claimed:

1. A method of applying a colorant to a contact lens mold, comprising:
maintaining an overpressure of inert gas in an inert atmosphere chamber that comprises at least one contact lens mold and at least one isolation shutter;
opening said isolation shutter;
introducing a printing comprising colorant into said chamber;
applying said colorant to said contact lens mold;
removing said printing device from said chamber; and
closing said isolation shutter.

2. The method according to claim 1, wherein said inert atmosphere chamber comprises less than about 0.5 weight percent oxygen prior to opening said isolation shutter.

3. The method according to claim 1, wherein said inert atmosphere chamber comprises less than about 3 weight percent oxygen while said isolation shutter is opened.

4. The method according to claim 1, wherein said inert atmosphere chamber comprises less than about 0.5 weight percent oxygen, said percent oxygen being measured at about 2 seconds after closing said isolation shutter.

5. The method according to claim 1, wherein said isolation shutter slidably opens and closes.

6. The method according to claim 1, wherein said isolation shutter remains open for less than about 2 seconds.

7. The method according to claim 1, wherein said inert gas comprises nitrogen.

8. The method according to claim 1, wherein said overpressure of inert gas gives rise to an inert gas velocity of at least about 0.5 meters per second measured using an anemometer positioned adjacent to an opening in the inert atmosphere chamber, said opening being provided by maintaining said isolation shutter in the opened position.

9. The method according to claim 1, wherein said colorant is applied by pad stamping said colorant to said contact lens mold.

10. A contact lens mold printing system, comprising:
an inert atmosphere chamber being capable of conveying a contact lens mold therethrough, said inert atmosphere chamber capable of maintaining an inert atmosphere environment;
an isolation shutter on said inert atmosphere chamber being capable of opening and closing; and
a printing mechanism being located external to said inert atmosphere chamber, said printing mechanism being capable of applying a colorant to the contact lens mold in the chamber when said isolation shutter is opened.

11. The contact lens mold printing system of claim 10, wherein said inert atmosphere environment comprises less than about 0.5 weight percent oxygen.

12. The contact lens mold printing system of claim 10, wherein said inert atmosphere chamber further comprises an inert gas inlet.

13. The contact lens mold printing system of claim 12, wherein said inert atmosphere chamber further comprise an inert gas outlet.

14. The contact lens mold printing system of claim 10, wherein said inert atmosphere chamber comprises at least two isolation shutters.

15. The contact lens mold printing system of claim 10, wherein said isolation shutter is capable of slidably opening and closing.

16. The contact lens mold printing system of claim 15, further comprising a gasket capable of being in sealable contact with said inert atmosphere chamber and said isolation shutter.

17. The contact lens mold printing system of claim 10, wherein said printing mechanism further comprises a stamping pad.

18. The contact lens mold printing system of claim 14, further comprising two or more printing mechanisms.

19. The contact lens mold printing system of claim 10, wherein said printing mechanism is located in air.

20. An isolation shutter capable of minimizing the exposure of oxygen to contact lens molds in an inert environment and capable of drying printer pads, said isolation shutter comprising a plate slidably situated adjacent to said inert environment, said plate comprising at least one edge and a surface, said at least one edge comprising at least one gas inlet port, said surface comprising at least one gas outlet port, wherein said plate comprises at least one channel in fluidic communication between said gas inlet port and said gas outlet port.

21. A method of applying a colorant to a contact lens mold, comprising:
maintaining an overpressure of inert gas in an inert atmosphere chamber comprising at least one contact lens mold;
introducing a printing device comprising colorant into said chamber;
applying said colorant to said contact lens mold; and
removing said printing device from said chamber.
